(19) United States
(12) Patent Application Publication
(10) Pub. No.: US 2026/0311268 A1
(43) Pub. Date: Oct. 8, 2026

(54) ITEM CHARACTER AI-MODEL SELECTION AND DESCRIPTION GENERATION

(71) Applicant: DoorDash, Inc., San Francisco, CA (US)

(72) Inventors: Yilin Ren, Kirkland, WA (US); Joel Ruben Antony Moniz, Santa Clara, CA (US); Zheng Hu, Jersey City, NJ (US); Ying Yang, Cupertino, CA (US)

(73) Assignee: DoorDash, Inc., San Francisco, CA (US)

(21) Appl. No.: 19/636,468

(22) Filed: Apr. 1, 2026

Related U.S. Application Data
(60) Provisional application No. 63/782,821, filed on Apr. 3, 2025.

(51) Int. Cl. G06Q 50/12

(52) U.S. Cl. CPC G06Q 50/12

(57) ABSTRACT

A method includes receiving, by a computer comprising one or more machine learning models, a plurality of input data elements relating to a food item offered by a service provider. The computer, in response to receiving the input data elements, generates a description of the food items by using the one or more machine learning models. The computer provides the description of the food item to a client site for display in a menu.

### CROSS REFERENCE TO RELATED APPLICATIONS

This application is a non-provisional application 63/782,821, filed on Apr. 3, 2025, which is herein incorporated by reference in its entirety for all purposes.

### BRIEF SUMMARY

One embodiment is directed to a method for generating a menu description for a food item, the method comprising: receiving, by a server computer comprising a processor and memory, a set of input data elements associated with the food item; determining, by the server computer, one or more characteristics of the set of input data elements; selecting, by the server computer from a plurality of distinct machine learning models, one or more machine learning models based on the determined one or more characteristics; generating, by the server computer using the selected one or more machine learning models, a description for the food item based on the set of input data elements; and providing, by the server computer, the generated description to a client computer for display in an online menu.

Another embodiment is directed to a server computer comprising a processor and a memory storing instructions that, when executed by the processor, cause the server computer to perform a method comprising: receiving a set of input data elements associated with a food item; determining one or more characteristics of the set of input data elements; selecting, from a plurality of distinct machine learning models, one or more machine learning models based on the determined one or more characteristics; generating, using the selected one or more machine learning models, a description for the food item based on the set of input data elements; and providing the generated description to a client system for display in an online menu.

Another embodiment is directed to a system comprising a client computer operated by a service provider and configured to transmit a set of input data elements associated with a food item, and a server computer communicatively coupled to the client computer. The server computer is configured to: receive the set of input data elements from the client computer; determine one or more characteristics of the set of input data elements; select, from a plurality of distinct machine learning models, one or more machine learning models based on the determined one or more characteristics; generate, using the selected one or more machine learning models, a description for the food item; and transmit the generated description for display.

These and other embodiments are described in further detail below.

Further details regarding embodiments of the disclosure can be found in the Detailed Description and the Figures.

### BRIEF DESCRIPTION OF THE DRAWINGS

FIG. 1 shows a block diagram of the system according to embodiments.

FIG. 2 shows a block diagram illustrating an exemplary embodiment of a central server computer.

FIG. 3 shows a flowchart illustrating an exemplary method for selecting a machine learning model based on characteristics of received input data elements.

FIG. 4 shows a diagram illustrating the inputs and output for an option model according to an embodiment.

FIG. 5 shows a diagram illustrating the inputs and output for a vision model according to an embodiment.

FIG. 6 shows a diagram illustrating the inputs and output for a common item model according to an embodiment.

FIG. 7 shows a diagram illustrating the inputs and output for a Retrieval-Augmented Generation (RAG) Model according to an embodiment.

FIG. 8 shows a flowchart for an asynchronous batch process and a real-time SSME (Self-Serve Menu Editor) process

FIG. 9 shows an example user interface that might be seen by a service provider when generating item descriptions.

### DETAILED DESCRIPTION

Prior to discussing embodiments of the disclosure, some terms can be described in further detail.

A “characteristic” may include a detectable property, attribute, or feature of the set of input data elements associated with the food item, wherein the characteristic is used by the server computer to guide the selection of one or more machine learning models for generating a description. Characteristics may relate to the structure, content, or absence of data within the set of input data elements. Examples of characteristics may include, but are not limited to: the presence or absence of specific data types, such as structured data corresponding to a plurality of selectable options or image data corresponding to a photograph of the food item; the classification of a data element, such as an item name matching an entry in a predefined list of common food items; a determination that the set of input data elements lacks a sufficient amount of information to meet a predetermined threshold, thereby indicating sparse data; or a specific user-defined parameter, such as a selected stylistic tone for the generated description.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the transporter user device can be integrated into a transportation device.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “service provider” may be an entity, such as a merchant or retailer, that makes one or more items available for acquisition by a user. While a service provider can be a merchant such as a restaurant, the term also encompasses a wide range of other commercial establishments that offer goods for sale or fulfillment. Examples of a service provider can include, but are not limited to, a grocery store, a convenience store, a pharmacy, a retail store selling consumer packaged goods, or a fulfillment center. In some embodiments, a service provider operates at one or more physical “service provider locations” and may utilize a “service provider computer” to communicate with a central server computer, for example, to receive order information for preparation and pickup by a transporter.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. In some embodiments, a route can be referred to as a journey. In some embodiments, a central server computer can route and automatically control (e.g., using a route map and control signals) an autonomous vehicle according to pick up an item from a service provider and deliver it to an end user.

A “query” can include a request for information. A query can include an instruction provided by a user or a user device to a computer system. In some embodiments, a query may comprise textual, voice, or structured data input that expresses the user’s intent to search, retrieve, or interact with information. A query may include keywords, phrases, questions, or commands, and may be accompanied by metadata such as user information, device type, location, or historical context. The query may be processed by computational models or algorithms to generate responses, retrieve documents, or perform actions relevant to the user’s intent.

A “machine learning computer” can include a device that creates, trains, and/or otherwise manipulates models. A machine learning computer can train a machine learning model.

A “machine learning model” (ML model) can include a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM),clustering (e.g., hierarchical clustering, k-means, mixture models, model-based clustering, density-based spatial clustering of applications with noise (DBSCAN), and OPTICS algorithm), approaches for learning latent variable models such as Expectation–maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

An “encoder” can process an input sequence to create a vector. Encoders can process input sequences to generate embedding vectors. An encoder can encode data from a higher dimensionality to a lower dimensionality. A “decoder” can process a vector to create an output sequence. Decoders can process embedding vectors, or vectors modified therefrom, to generate an output sequence. A decoder can decode data from a lower dimensionality to a higher dimensionality. Both encoders and decoders can be separate, fully connected neural networks. Encoders and decoders may be recurrent neural networks (RNNs) or variants thereof (e.g., long-short term memory (LSTM), gated recurrent units (GRUs), etc.) and convolutional neural networks (CNNs), as well as transformer models. An encoder-decoder model can include several encoders and several decoders.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A machine learning computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include a computational model trained on natural language datasets. A language model can include a large language model (LLM). A language model can be configured to generate, interpret, or analyze language. A language model may comprise a neural network architecture, such as a transformer-based model, having hundreds of millions or more parameters. A language model may be trained using supervised, unsupervised, or self-supervised learning techniques, and may be capable of performing tasks including natural language understanding, text generation, translation, summarization, question answering, and semantic search.

An “embedding” can include numerical representations. An embedding can include a vector. An embedding can be a lower-dimensional vector that is derived from complex high-dimensional data.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a cloud server, a database server coupled to a Web server. The server computer may comprise one or more computational apparatuses and may use any of a variety of computing structures, arrangements, and compilations for servicing the requests from one or more client computers.

In the context of online platforms, such as food delivery services, the quality and completeness of a menu can significantly impact an end user’s desire to obtain food items on the menu. Service providers, such as restaurants, desire detailed, appealing, and accurate menu item descriptions. However, manually crafting high-quality descriptions for every item on a menu can be a time-consuming and resource-intensive task, particularly for smaller, local establishments that may lack dedicated staff for this purpose. This can lead to a significant "description gap," where smaller restaurants may have menu description coverage as low as 58%, compared to 85% for larger enterprise restaurants. This disparity leaves smaller businesses at a disadvantage, as consumers often hesitate to order items without critical information about ingredients or preparation.

Simply providing a menu item name to an artificial intelligence (AI) or machine learning (ML) model to infer the description for the menu item is challenging. This is because different service providers/restaurants may desire to phrase their descriptions differently and because service providers/restaurants may prepare food items differently. For instance, depending upon the restaurant, common dishes such as “chili chicken” may consist entirely of chicken or may contain vegetables.

Embodiments of the invention are directed towards methods and systems for automatically generating menu descriptions using artificial intelligence (AI) to bridge this gap. In embodiments of the invention, a central server computer can receive various input data elements related to a food item, intelligently select an appropriate machine learning model from a plurality of specialized models, and generate a high-quality description tailored to the item. This automated process allows service providers to easily and efficiently populate their menus with compelling descriptions, thereby enhancing the end user’s experience and improving their online presence.

One notable technical approach employed by the machine learning models in embodiments of the invention is a combination of conditional text generation and in-context learning. This combination allows for a high degree of control over the AI model's output, ensuring both factual accuracy and stylistic quality without needing to retrain the models for each task.

Conditional text generation refer to the process of generating text that is dependent on, or "conditioned by," a specific set of inputs. Rather than generating a generic description, the model is provided with a set of strict conditions—such as the item name, specific ingredients, or required options—that its output must adhere to. This directly combats the problem of AI "hallucination" (i.e., the generation of incorrect or irrelevant information) by binding the model's output to the facts provided by the merchant.

In-context learning (sometimes known as "few-shot learning") is a technique where the model learns to perform a task based on instructions and examples provided within the prompt itself. Before being asked to generate a new description, the model is presented with several examples of high-quality inputs and their corresponding outputs. From these examples, the model discerns the desired pattern, including the tone, structure, and format of the output. This allows the system to control the style of the generated descriptions and even offer different tones (e.g., playful, descriptive) to service providers. Together, these techniques enable the system to produce descriptions that are not only accurate but also stylistically consistent and aligned with a service provider's brand.

Embodiments of the disclosure allow for artificial intelligence and machine learning techniques to analyze a restaurant’s menu and provide descriptions tailored to the restaurant.

Embodiments of the invention provide numerous technical advantages. For example, the multi-model architecture overcomes challenges of variety by routing tasks to specialized models. The system is designed for scalability, using parallel processing to reduce generation time by at least ten times, enabling the generation of descriptions for a million items in a single day. The system also actively controls AI hallucination and quality by relying on service provider-provided data as a source of truth and occasionally incorporating human-in-the-loop review processes.

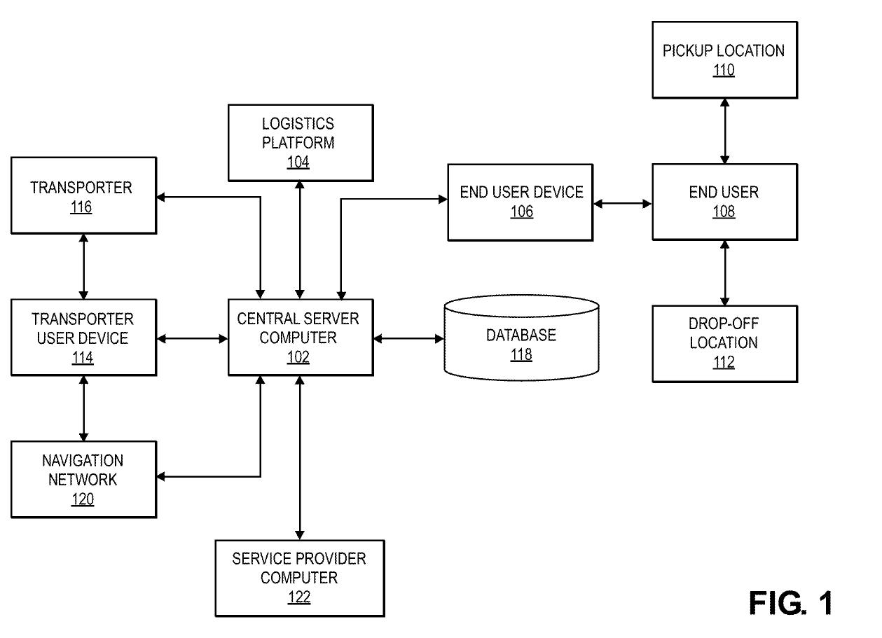

FIG. 1 shows a system 100 that can be used in the context of embodiments of the invention. The system of FIG. 1 includes a central server computer 102, a logistics platform 104, an end user device 106, an end user 108, a pickup location 110, a drop-off location 112, a transporter user device 114, a transporter 116, a navigation network 120, a service provider computer 122, and a database 118.

The central server computer 102 can be in operative communication with the logistics platform 104, the end user device 106, the transporter user device 114, the navigation network 120, the service provider computer 122, and the database 118. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows a transporter 116, there can be two, three, or more transporters, transporter user devices, etc. present in the system 100. Although one database 118 is shown, the system may include multiple databases storing different types of data.

In embodiments of the invention, the central server computer 102 can include a server computer that facilitates the generation of menu descriptions. The central server computer 102 can receive input data elements from the service provider computer 122, which is operated by a service provider such as a merchant. The service provider computer 122 can be considered a client computer when it is used by the service provider to interact with the central server computer 102 to generate menu descriptions. These input data elements may relate to a food item offered by the service provider operating the service provider computer 122 and can include, for example, an item name, item category, a list of selectable options, an image of the item, a cuisine type, etc.

The database 118 can include any suitable database for storing data related to the menu description generation process. For example, the databases 118 may store received input data elements, existing menu descriptions from a plurality of merchants, and newly generated descriptions.

The central server computer 102 may comprise a memory storing AI models such as machine learning models, which can represent a plurality of distinct models, each specialized for generating descriptions based on different types of input data. The central server computer can select and utilize one or more of these models to generate a description, which can then be provided to the service provider computer 122 (e.g., a client computer in this context) for display in an online menu. The online menu can be presented by the central server computer 102 to an end user 108 operating the end user device 106. The end user 108 can then order an item from the online menu and have that item delivered to the end user 108 using the transporter 116.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can also facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive a query from the end user device 106. The central server computer 102 can determine one or more documents based on the query. The central server computer 102 can provide the one or more documents relating to the query to the end user device 106.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., the service provider’s or merchant’s location) and deliver the item to the drop-off location 112 (e.g., the end user’s location).

The pickup location 110 can be a location in which items are stored. In the context of an outbound delivery from an end user at an end user location, examples of the pickup location 110 may be a service provider location (e.g., a retail store, a grocery store, a dry cleaning store), a pickup hub, etc. Items can first be obtained from the pickup location 110 and then be transported to the drop-off location 112. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user’s fulfillment request via an acceptance message. For example, the transporter user device 114 can generate and transmit a request to fulfil a particular end user’s fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can operated by an operator or can be autonomous. The vehicle can include a car, a truck, a van, a motorcycle, a bicycle, a drone, or other vehicle.

The navigation network 120 can provide navigational directions to the transporter user device 114 via the central server computer 102. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114. If the transporter is an autonomous vehicle that includes the transporter user device 114, the transporter user device 114 can receive control signals from the central server computer 102 to cause the autonomous vehicle to travel according to one or more service provider locations to fulfill a fulfillment plan.

The service provider computer 122 can be operated by a service provider. For example, the service provider can be restaurant that prepares food for end users. The service provider computer 122 can offer to provide items or services to the end user 108 of the end user device 106. In embodiments of the invention, the service provider computer 122 can receive requests to prepare or obtain one or more items for delivery from the central server computer 102. The service provider computer 122 can initiate the preparation or collection of the one or more items that are to be delivered to the end user 108 of the end user device 106 by the transporter 116 of the transporter user device 114.

The database 118 can include any suitable database. The database may be a conventional, fault tolerant, relational, scalable, secure database such as those commercially available from Oracle™ or Sybase™. The database 118 can store data related to fulfillment requests.

The central server computer 102 can determine fulfillment plans comprising how orders will be fulfilled. The fulfillment plans can include end user preferences and delivery window constraints, the requested items, a set of service provider locations to source the requested items, and other constraints for the order (e.g., personal shopper request).

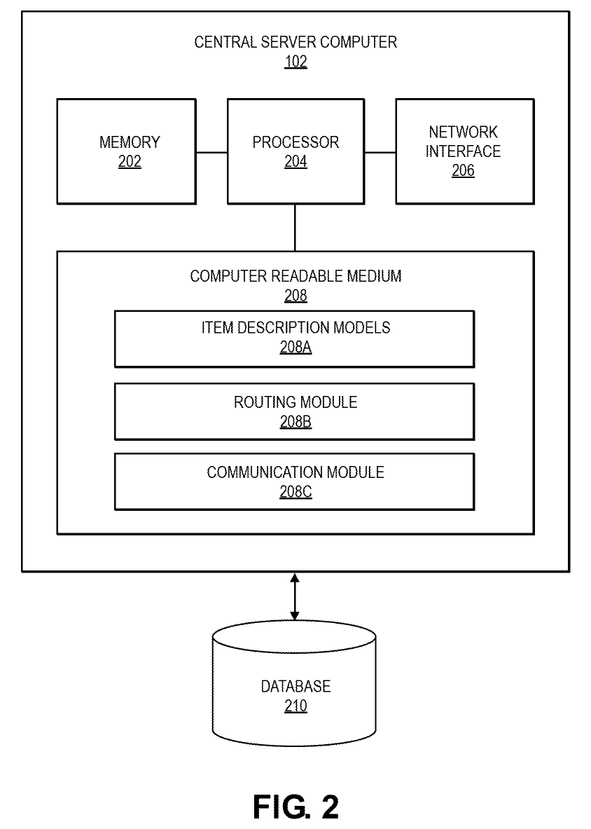

FIG. 2 shows a block diagram of a central server computer 102 according to embodiments. The exemplary central server computer 102 may comprise a processor 204. The processor 204 may be coupled to a memory 202, a network interface 206, and a computer readable medium 208. The computer readable medium 208 can comprise item description models 208A, a routing module 208B, and a communication module 208C.

The memory 202 can be used to store data and code, such as input data elements, generated descriptions, and machine learning model parameters. The memory 202 may be coupled to the processor 204 internally or externally and may comprise any combination of volatile and/or non-volatile memory.

The computer readable medium 208 may comprise code, executable by the processor 204, for performing a method comprising: receiving a set of input data elements associated with a food item; determining one or more characteristics of the set of input data elements; selecting, from a plurality of distinct machine learning models, one or more machine learning models based on the determined one or more characteristics; generating, using the selected one or more machine learning models, a description for the food item based on the set of input data elements; and providing the generated description to a client computer for display in an online menu.

The item description models 208A may comprise the software and logic for the plurality of distinct machine learning models used to generate descriptions. This can include an option model, a vision model, a common item model, and a retrieval-augmented generation (RAG) model. The item description models 208A may also include the logic for selecting the appropriate model or models based on the input data.

The routing module 208B may route transporters delivering items to end users. The routing module 208B can generate display and/or control data which can be transmitted to transporter user devices and/or the transporters. Such data may be used to facilitate the delivery of items from service providers to end users.

The communication module 208C may facilitate communication among entities. The communication module 208C can include code for causing the central server computer to receive and transmit messages to various external devices, such as the end user device 106.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the transporter 116, the database 118, the navigation network 120, the service provider computer 122, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi^{TM}. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

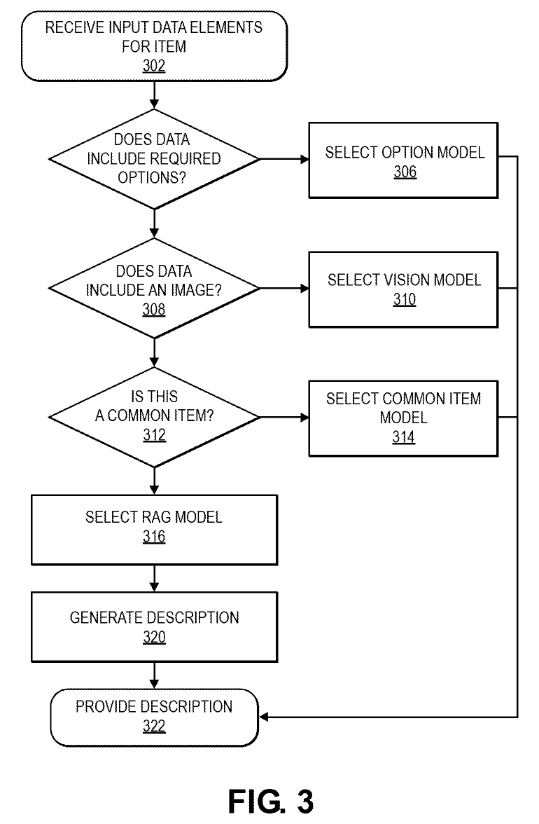

FIG. 3 illustrates a flowchart of a method for selecting a machine learning model. This method acts as an intelligent routing mechanism that classifies items into distinct cohorts to ensure that the most suitable model is used for a given set of inputs. The process begins at step 302, where the server computer receives input data elements for a food item. At step 304, the server determines if the data includes required, selectable options, which corresponds to a cohort of items with structured choices. If yes, the server selects the option model at step 306. If no, the process moves to step 308 to determine if the data includes an image, corresponding to a cohort of items with approved photos. If yes, the server selects the vision model at step 310. If no, the process moves to step 312 to determine if the item is a common item (a cohort of items shared across cuisines). If yes, the server selects the common item model at step 314. If none of the preceding conditions are met, the item is classified as an uncommon, cuisine-specific item with sparse data, and the server defaults to selecting the robust RAG model at step 316. Once a model is selected, the server generates a description at step 320 and provides the description for display at step 322.

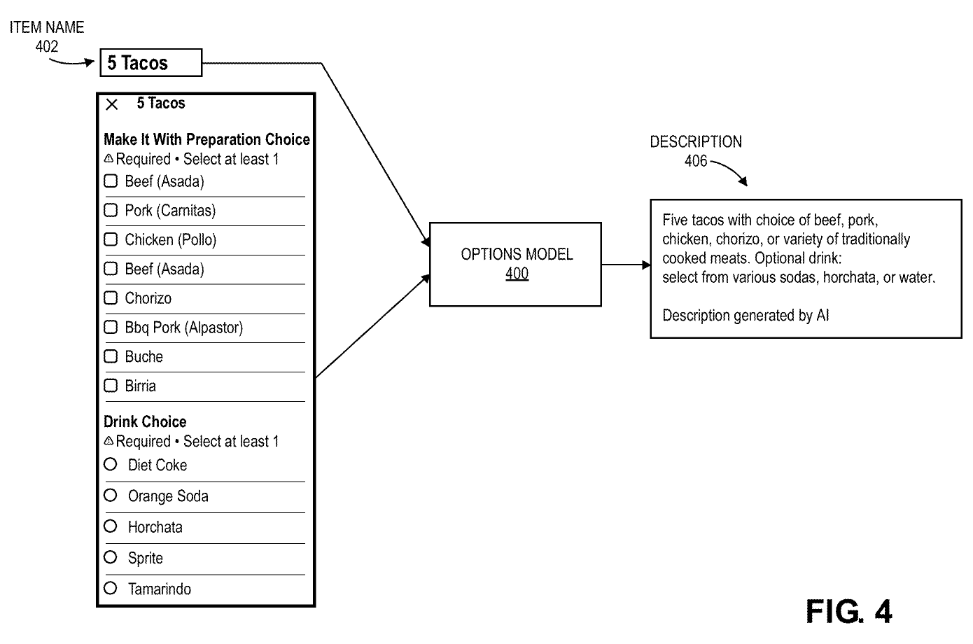

FIG. 4 illustrates the operation of the option model 400. This model can be designed for items where the merchant provides specific, structured choices for the consumer. The model receives inputs such as an item name 402 (e.g., "5 Tacos") and a list of required item options 404 (e.g., choices of meat such as beef, pork, chicken, birria, etc., and drink such as cola, orange soda, horchata, etc.). By employing techniques such as conditional text generation and in-context learning, the model is conditioned on these specific inputs to generate a description 406 that accurately reflects the available choices, such as: “Five tacos with a choice of beef, pork, chicken, chorizo, or a variety of traditionally cooked meats. Optional drink: select from various sodas, horchata, or water.” This ensures the description is not only appealing but also factually correct based on the service provider's own data.

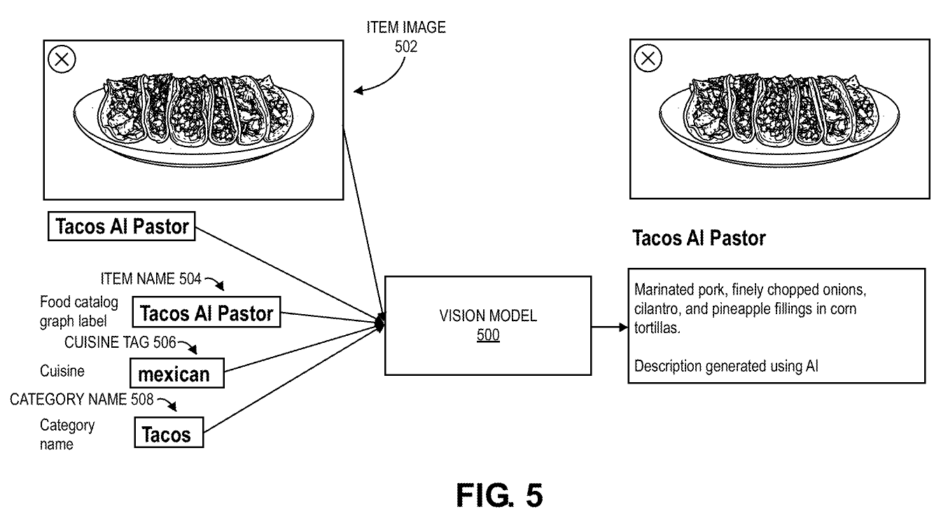

FIG. 5 illustrates the operation of the vision model 500. This model is used when a merchant has provided a photograph of the food item. The model receives inputs including an item image 502, an item name 504, a cuisine tag 506, and a category name 508. The vision model analyzes the visual characteristics of the item in the image in conjunction with the text-based inputs to generate a relevant description 510 that captures visual details. For instance, for an item named “Tacos al Pastor” with an accompanying photo, a food catalog label such as “Tacos al Pastor,” a cuisine of “Mexican,” and a category name of “Tacos,” the model may generate: “Marinated pork, finely chopped onions, cilantro, and pineapple fillings in corn tortillas.”

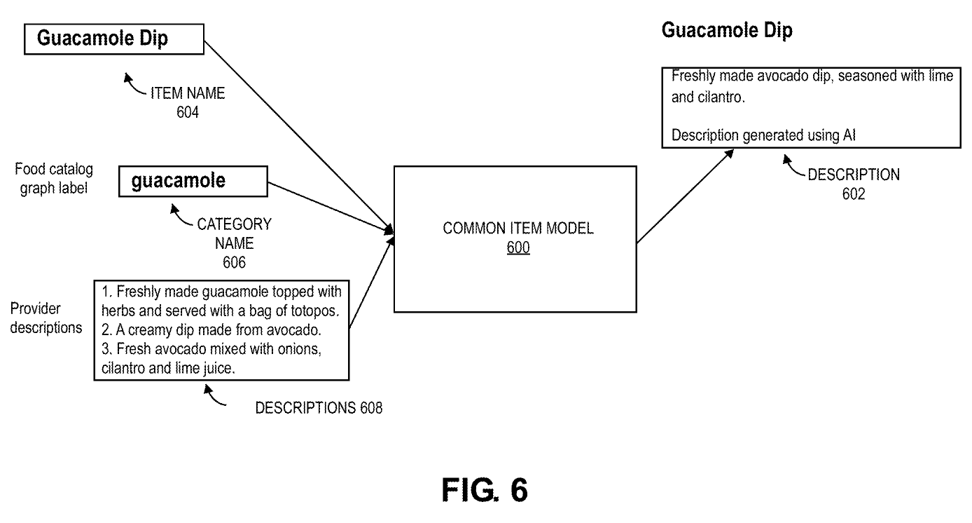

FIG. 6 illustrates the operation of the common item model 600. This model can generate standardized descriptions for items that lack service provider-provided details (e.g., water) and apply them consistently across the platform. It can categorize common items, including staples. Examples of such common items can include water, lemonade, tiramisu, and guacamole dip. The common item model receives inputs such as an item name 604 (e.g., “guacamole dip”), a category name 606 (e.g., “guacamole”), and existing service provider descriptions 608 (e.g., “1. Freshly made guacamole topped with herbs and served with a bag of totopos. 2. A creamy dip made from avocado. 3. Fresh avocado mixed with onions, cilantro, and lime juice.”), which may be of top-performing or highly converted items from different service providers for the same item. The model uses these inputs to generate a standardized and high-quality description 602. For example, a finalized description for Guacamole Dip might be: “Freshly mashed avocado dip, seasoned with lime and cilantro.”

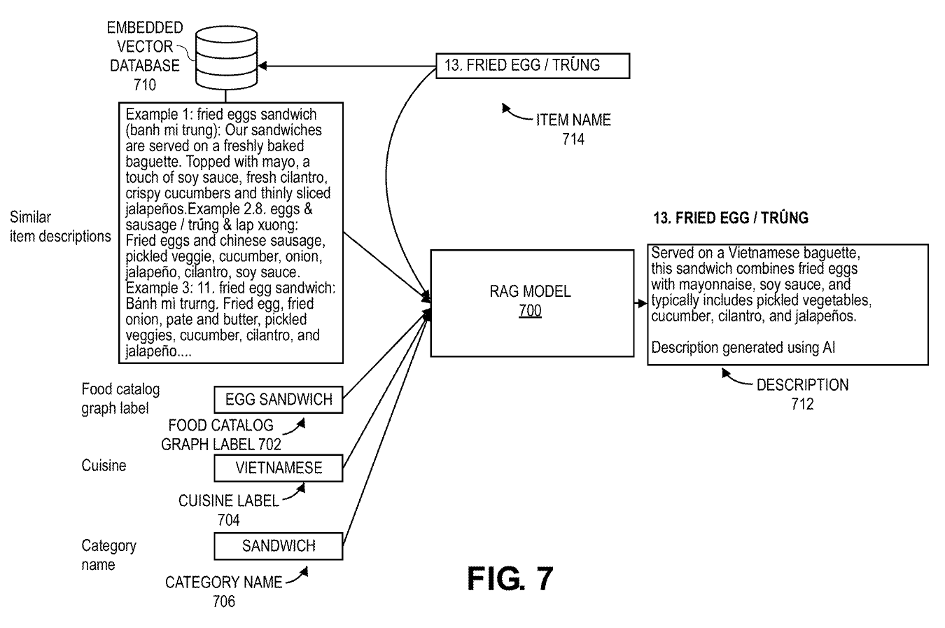

FIG. 7 illustrates the operation of the Retrieval-Augmented Generation (RAG) Model 700. This model is used for handling items with limited or sparse information, where other models might lack sufficient input to generate a high-quality description. The process begins when the model receives a set of input data elements such as a food catalog graph label 702 (e.g., egg sandwich), a cuisine label 704 (e.g., Vietnamese), a category name 706 (e.g., sandwich), and an item name 714 (e.g., Fried Egg/Trứng).

The RAG model's technical process involves the generation and comparison of embeddings within a specialized vector database 710. An embedding is a dense numerical vector that serves as a mathematical representation of the semantic meaning of the input data in a high-dimensional vector space. For example, the item name 714 (e.g., Fried Egg/Trứng) can be input into and processed by a pre-trained neural network encoder. The encoder transforms the textual and categorical data into a single, fixed-length query vector.

This generated query vector is then used to perform a similarity search against a large, pre-indexed collection of embeddings stored in the vector database 710. Each embedding in this database corresponds to an existing menu item for which a description is already available. The search operation is not a simple keyword match; instead, it is a mathematical calculation to find the "k" nearest neighbors to the query vector. This is typically achieved by calculating a distance metric, such as cosine similarity, which measures the cosine of the angle between two vectors. A smaller angle (and thus a cosine similarity closer to 1) indicates a higher degree of semantic relevance. The vector database 710 is specifically optimized for this task, often employing Approximate Nearest Neighbor (ANN) search algorithms to perform this high-dimensional search with immense speed and efficiency, a significant technical improvement over a conventional, computationally expensive linear database scan.

Once the embeddings of the top “n” (e.g., 30-50) most semantically similar items are identified through this search, the system retrieves their corresponding full-text descriptions from a standard database. These retrieved descriptions—which are known to be relevant and well-formed—are then used as a rich, contextual input, along with the original query, for a generative language model. This final step generates a new description 712 that is grounded in the patterns, vocabulary, and ingredient combinations found in the retrieved examples.

This approach is particularly effective for unique or cuisine-specific items. For example, for the item “Fried Egg/Trứng” from a Vietnamese restaurant, the RAG model can retrieve descriptions from similar Banh Mi sandwiches and generate a highly specific and helpful description: “Served on a Vietnamese baguette, this sandwich combines fried eggs with mayonnaise, soy sauce, and typically includes pickled vegetables, cucumber, cilantro, and jalapenos.” This demonstrates a specific technical solution to the problem of sparse data by leveraging a sophisticated process of semantic vector representation and high-performance similarity search.

In further embodiments of the invention, the selection of a machine learning model is not limited to a single, exclusive choice as depicted in the simplified flowchart of FIG. 3. The system may be configured to employ a hybrid or combinatorial approach, utilizing two or more models in combination to generate a description of superior quality and detail. This allows the system to leverage the strengths of each specialized model when an item possesses multiple rich characteristics.

For example, consider a food item for which the received input data elements include both a high-quality image and a plurality of selectable options (e.g., a "build-your-own" burger with a photo). In such a scenario, the system may determine that characteristics for activating both the vision model and the option model are present. The vision model can be executed to analyze the image and extract descriptive visual features, such as color ("golden-brown brioche bun"), texture ("perfectly melted cheese"), ingredients visible in the image ("topped with crisp lettuce and a ripe tomato slice"), and presentation style ("served with a side of seasoned curly fries"). Simultaneously or sequentially, the option model can be executed to process the structured option data to identify and formulate phrases related to user customization, such as "your choice of a 1/3 lb. beef, grilled chicken, or plant-based patty" or "add avocado or bacon for an additional charge."

The outputs or intermediate data from both models—the unstructured visual descriptors and the structured customization phrases—can then be provided as a combined set of enriched input conditions to a final text generation step. This final step synthesizes the visual details from the vision model with the customization details from the option model to produce a single, cohesive, and highly detailed description. The resulting description is thereby rendered more comprehensive and appealing than a description generated by either model alone. It combines the evocative, visual language derived from the photograph with the practical, choice-oriented information from the options, providing a complete and enticing picture of the food item for the consumer. This hybrid approach can be extended to other model combinations as well. For instance, the RAG model could be used to retrieve a base description for an uncommon item, which is then enhanced with visual details extracted by the vision model if a photo is available. By combining the strengths of the specialized models, the system can generate descriptions that are maximally informative, accurate, and persuasive.

The machine learning models utilized in embodiments of the invention are not static; they are configured to be periodically retrained and fine-tuned over time to continuously improve their performance. This improvement is driven by a robust feedback loop that leverages data generated from the system's real-world operation. The ongoing training process ensures that the generated descriptions become progressively more accurate, stylistically aligned with merchant and consumer preferences, and effective at driving consumer engagement. The training data for this process is sourced from several channels, including service edits made within the Self-Serve Menu Editor (SSME), performance metrics from A/B testing (e.g., conversion rates associated with specific descriptions), and data from human-in-the-loop review processes.

In some embodiments, the option and vision models can be fine-tuned using a supervised learning approach. A source of training data comes from the SSME feedback loop. For example, when a merchant initiates a request and the system generates a description using either the option model or the vision model, the merchant has the opportunity to edit and save the description. This act of editing and saving creates a high-quality, labeled training example. Each example consists of the initial input data elements (e.g., item name, options, and/or image) paired with the final, merchant-approved description as the ground-truth label. Large datasets of these pairs are collected and used to fine-tune the underlying generative language models. This process trains the models to better correlate specific inputs—such as the names of options or visual features in an image—with the natural language phrases that service providers prefer, improving the models' fluency and accuracy.

The common item model is improved through a process of ongoing data curation and performance analysis rather than traditional model retraining. The system continuously collects performance data for the standardized descriptions used for common items. This data includes A/B testing results that measure the conversion rate and consumer engagement for different description variants. Over time, underperforming descriptions can be automatically flagged for review, while high-performing descriptions are reinforced. Human reviewers can then analyze this data to select the most effective descriptions, which become the new "golden" templates for common items. This data-driven curation process ensures that the standardized descriptions are optimized for commercial effectiveness.

The RAG model can comprise at least two components that are independently improved: the retriever (embedding model) and the generator (language model). The retriever is fine-tuned to improve its ability to identify truly similar items. This is achieved using techniques like contrastive learning, where the embedding model is trained on a dataset of item triplets: an "anchor" item, a "positive" (similar) item, and a "negative" (dissimilar) item. The model learns to minimize the vector distance in the embedding space between the anchor and positive items while maximizing the distance between the anchor and negative items. This refines the embedding model's understanding of semantic similarity specifically within the food domain. The generator component is fine-tuned using the same feedback loop as the option and vision models. When the RAG model generates a description that a merchant subsequently edits, a new training example is created, consisting of the original query, the retrieved contextual descriptions, and the final merchant-approved text. This trains the generator to become more adept at synthesizing information from multiple retrieved sources into a single, coherent, and high-quality description.

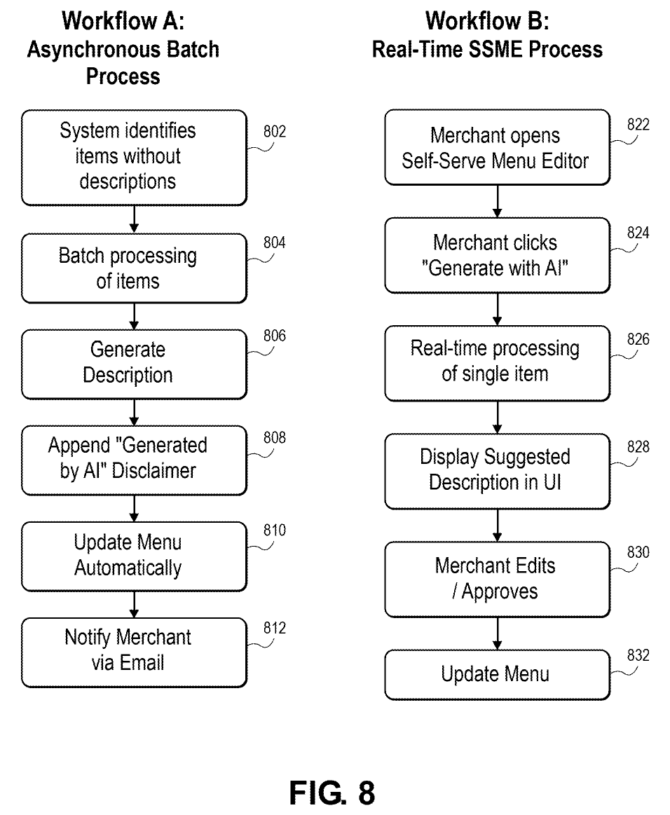

FIG. 8 shows a diagram illustrating two distinct workflows for generating menu descriptions: an asynchronous, system-initiated batch process and a real-time, merchant-initiated interactive process. These two modes of operation allow the system to flexibly accommodate the needs of different merchants, both those who actively manage their menus and those who do not.

The first workflow, an asynchronous batch process, is depicted on the left side of FIG. 8. This process is designed for merchants who do not frequently engage with the menu management tools, and it operates automatically to improve menu quality without requiring direct merchant intervention. The process begins at step 802, where the system automatically identifies items within a merchant's menu that are missing a description. This identification can be performed periodically, for example, as part of a weekly automated pipeline. At step 804, the identified items are grouped together for efficient batch processing. This allows the system to handle a high volume of items from multiple merchants at once, improving scalability.

At step 806, the server computer generates a description for each item in the batch, using the model selection logic described in FIG. 3 to route each item to the most appropriate machine learning model. Following generation, at step 808, a disclaimer is appended to each description, such as “Description generated using AI.” This step ensures transparency for the end consumer. At step 810, the menu is updated automatically with the newly generated and disclaimed descriptions. Finally, at step 812, the system notifies the merchant of the update, for example, via email, informing them that descriptions have been added and can be edited at any time.

The second workflow, a real-time process initiated by a merchant, is depicted on the right side of FIG. 8. This workflow is designed for merchants who are actively managing their menu items. The workflow begins at step 822 when a merchant accesses a Self-Serve Menu Editor (SSME) interface on a user device. At step 824, the merchant actively requests an AI-generated description for a specific item, for instance, by clicking a "Generate with AI" button.

In response, at step 826, the system performs real-time processing for the single item requested by the merchant. At step 828, the newly generated description is displayed to the merchant within the user interface, allowing for immediate review. At step 830, the merchant has the opportunity to review, edit, or approve the suggested description directly. Because the merchant actively curates the content, these descriptions are treated as merchant-provided, and no disclaimer is necessary. Once the merchant is satisfied, at step 832, the menu is updated with the final description. By providing these two distinct workflows, the system can effectively bridge the "description gap" for all types of service providers on the platform.

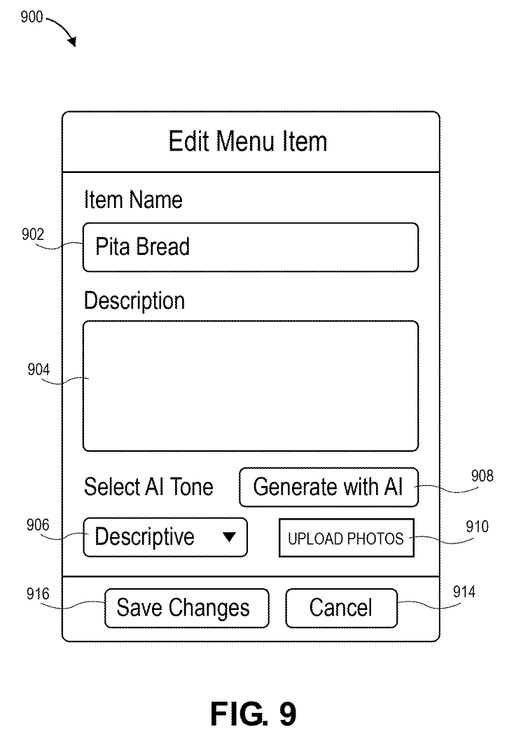

FIG. 9 shows an exemplary graphical user interface (GUI) 900 that may be presented to a merchant on a client computer as part of a Self-Serve Menu Editor (SSME), according to an embodiment. This interface facilitates the real-time, merchant-initiated workflow for generating and refining menu item descriptions.

The GUI 900 may be displayed as a window or a panel within a larger application and includes a title, "Edit Menu Item," indicating its function. The interface is organized to allow a service provider to easily manage the details of a specific food item. It includes an item name label and an associated item name text input field 902, which may be populated with the name of the item being edited, such as "Pita Bread."

Below the item name fields, the GUI 900 includes a description label and a corresponding description text area 904. This text area can be a multi-line field where the AI-generated description will be displayed and/or where the service provider can manually enter or edit text.

To facilitate the AI-powered generation, the GUI 900 includes several interactive elements. A "Generate with AI" button 908 serves as the primary control for a merchant to initiate a request to the server computer to generate a description for the item identified in the item name field 902. In some embodiments, the interface also includes a tone selection dropdown menu 906, labeled "Select AI Tone." This element allows the service provider to provide an additional input data element specifying a desired stylistic tone for the generated description, such as "Descriptive," "Playful," or "Concise."

Finally, the GUI 900 includes action buttons to complete or cancel the editing process. A "Save Changes" button 916 allows the merchant to approve the description in the text area 910 and save it to the menu. A "Cancel" button 914 allows the merchant to discard any changes and close the interface. An “Upload Photos” button 910 can allow the service provider to upload photos of items. In operation, a merchant can use this interface to trigger the real-time generation process, review the result in the description text area 904, make any desired modifications, and save the final description to their menu.

The system according to embodiments of the invention provide for a significant improvement to the functioning of the server computer itself. Unlike conventional systems that might use a single, generic text-generation model, the claimed invention employs a specific, multi-model architecture comprising a plurality of distinct, specialized machine learning models. The server computer is configured with a specific logic-based routing mechanism (as shown in FIG. 3) to analyze the characteristics of incoming data and intelligently select the most appropriate model or combination of models. This is not a generic computer performing its ordinary functions; it is a specifically programmed machine designed to overcome the technical challenge of matching diverse data inputs to specialized processing modules, thereby improving the efficiency and accuracy of the computer's operation.

Furthermore, the system is engineered for scalability to solve the technical problem of generating millions of descriptions in a commercially viable timeframe. The instructions for routing requests for parallel processing across the different models represent a specific implementation that improves the computer's throughput and enables the system to operate at a scale previously unattainable with manual or generic methods. The use of a Retrieval-Augmented Generation (RAG) model in conjunction with an embedding vector database constitutes a specific data structure and retrieval process that improves the computer's ability to handle sparse or incomplete data, a known technical problem in data processing.

Embodiments of the invention provides a technical solution to the technical problem of the "description gap" in online e-commerce and menu platforms. This gap is not merely a business problem but a deficiency in the human-computer interface, where a lack of critical data leads to user hesitation and inefficient navigation of the platform. Prior art systems relied on manual data entry, which is technologically limiting and unscalable, or generic templates, which fail to provide accurate, context-specific information.

Embodiments of the invention overcome these limitations by providing a technological solution that automatically creates a more data-rich, effective, and reliable user interface for consumers. It specifically addresses the technical challenge of AI "hallucination" by employing conditional text generation, which grounds the output in merchant-provided data, and by using the RAG model to ground outputs in existing, real-world examples. This improves the integrity and reliability of the data presented to the end-user, resulting in a more dependable and functional online platform. The system therefore represents a specific improvement to the technical field of digital content presentation and management.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of "a," "an," or "the" is intended to mean "at least one," unless specifically indicated to the contrary.

What is claimed is:

1. A method for generating a menu description for a food item, the method comprising:
receiving, by a server computer comprising a processor and memory, a set of input data elements associated with the food item;
determining, by the server computer, one or more characteristics of the set of input data elements;
selecting, by the server computer from a plurality of distinct machine learning models, one or more machine learning models based on the determined one or more characteristics;
generating, by the server computer using the selected one or more machine learning models, a description for the food item based on the set of input data elements; and
providing, by the server computer, the generated description to a client computer for display in an online menu.

2. The method of claim 1, wherein the one or more selected machine learning models comprise an option model, and wherein determining the one or more characteristics comprises identifying that the set of input data elements includes a plurality of selectable options for the food item, the option model configured to generate the description based at least in part on the plurality of selectable options.

3. The method of claim 1, wherein the one or more selected machine learning models comprise a vision model, and wherein determining the one or more characteristics comprises identifying that the set of input data elements includes an image of the food item, the vision model configured to generate the description based on a visual analysis of the image.

4. The method of claim 1, wherein the one or more selected machine learning models comprise a common item model, and wherein determining the one or more characteristics comprises identifying the food item as a common food item present across a plurality of service providers, the common item model configured to generate the description based on a plurality of existing descriptions for the common food item from the plurality of service providers.

5. The method of claim 1, wherein the one or more selected machine learning models comprise a Retrieval-Augmented Generation (RAG) model, and wherein determining the one or more characteristics comprises identifying that the set of input data elements lacks a predefined set of information.

6. The method of claim 5, wherein the RAG model is configured to generate the description by:
retrieving, from a database, a plurality of existing descriptions corresponding to food items determined to be similar to the food item; and
using the plurality of existing descriptions as input to generate the description.

7. The method of claim 1, wherein the method further comprises:
providing, by the central server computer, one or more communications including the generated description in the online menu to an end user device, the online menu associated with a restaurant; and
receiving a fulfillment request from the end user device indicating that the food item is to be delivered to the end user, wherein the one or more transporters operating the one or more transport user devices satisfy the fulfillment request by delivering, by a transporter, the food item to the end user to satisfy the fulfillment request.

8. The method of claim 1, wherein the set of input data elements is received in real-time from a self-serve menu editor operated by a service provider, and wherein the generated description is provided to the self-serve menu editor for review and approval by the service provider.

9. The method of claim 8, wherein the set of input data elements further includes a selected tone, and wherein the selected one or more machine learning models generate the description to conform to the selected tone.

10. The method of claim 1, further comprising routing a plurality of description generation requests to the plurality of distinct machine learning models for parallel processing to generate descriptions for a plurality of different food items concurrently.

11. A server computer, comprising:
a processor; and
a memory storing instructions that, when executed by the processor, cause the server computer to:
receive a set of input data elements associated with a food item;
determine one or more characteristics of the set of input data elements;
select, from a plurality of distinct machine learning models, one or more machine learning models based on the determined one or more characteristics;
generate, using the selected one or more machine learning models, a description for the food item based on the set of input data elements; and
provide the generated description to a client computer for display in an online menu.

12. The server computer of claim 11, wherein the one or more selected machine learning models comprise an option model, and wherein the instructions that cause the server computer to determine the one or more characteristics comprise instructions to identify that the set of input data elements includes a plurality of selectable options for the food item.

13. The server computer of claim 11, wherein the one or more selected machine learning models comprise a vision model, and wherein the instructions that cause the server computer to determine the one or more characteristics comprise instructions to identify that the set of input data elements includes an image of the food item.

14. The server computer of claim 11, wherein the one or more selected machine learning models comprise a Retrieval-Augmented Generation (RAG) model, and wherein the instructions that cause the server computer to determine the one or more characteristics comprise instructions to identify that the set of input data elements lacks a predefined set of information, and wherein the instructions further cause the server computer to:
retrieve, from a database, a plurality of existing descriptions corresponding to similar food items; and
use the plurality of existing descriptions as input to the RAG model to generate the description.

15. The server computer of claim 11, wherein the instructions to generate and provide steps are performed as part of an asynchronous batch process, and further wherein the instructions cause the processor to: append a disclaimer to the generated description indicating that the description was generated by an artificial intelligence system.

16. The server computer of claim 15, wherein the set of input data elements is received in real-time from a self-serve menu editor.

17. The server computer of claim 16, wherein the set of input data elements further includes a selected tone, and wherein the instructions cause the server computer to generate the description to conform to the selected tone.

18. A system, comprising:
a client computer operated by a service provider, the client computer configured to transmit a set of input data elements associated with a food item; and
a server computer communicatively coupled to the client computer, the server computer configured to:
receive the set of input data elements from the client computer;
determine one or more characteristics of the set of input data elements;
select, from a plurality of distinct machine learning models, one or more machine learning models based on the determined one or more characteristics;
generate, using the selected one or more machine learning models, a description for the food item; and
transmit the generated description for display.

19. The system of claim 18, wherein the client computer comprises a graphical user interface for a self-serve menu editor, and wherein the server computer is configured to transmit the generated description back to the client computer for display within the graphical user interface for review by the service provider.

20. The system of claim 19, wherein the graphical user interface is further configured to receive a user selection of a stylistic tone, and wherein the set of input data elements transmitted by the client computer includes the selected stylistic tone.
